(19) United States
(12) Patent Application Publication
(10) Pub. No.: US 2013/0098219 A1
(43) Pub. Date: Apr. 25, 2013

(54) Device and method for manufacturing cotton pads

(71) Applicant: Roweg Holding AG, Erlenbach ZH (CH)

(72) Inventors: Guy Petignat, Erlenbach (CH); Erich Matter, Buttikon (CH)

(73) Assignee: ROWEG HOLDING AG, ERLENBACH ZH (CH)

(21) Appl. No.: 13/653,545

(22) Filed: Oct. 17, 2012

(30) Foreign Application Priority Data
Oct. 24, 2011 (CH) 1717/11

(51) Int. Cl. D06H 7/00; D06H 7/24; B26F 1/14

(52) U.S. Cl. 83/685; 83/686; 83/13

(57) ABSTRACT

A device for separating textile parts such as cotton pads out of a textile sheet formation. The device includes at least one first tool component with a receiver opening for receiving separated-away textile parts, at least one second tool component cooperating with the first tool component and having a separating tool, for separating away textile parts out of the textile sheet formation. The first and the second tool components are designed movable to one another and relative to one another for separating away textile parts. The first tool component is designed as a die with a first cutting edge encompassing the die opening in a closed manner and the second tool component is designed as a working punch with a second cutting edge.

The invention relates to a device and to a method for manufacturing textile parts, in particular cotton pads, from a textile sheet formation, with which the textile parts are separated out of the textile sheet formation. Such a device contains at least one first tool component with a receiver opening for receiving separated-away textile parts, as well as at least one second tool component cooperating with the first tool component and with a separating tool for separating the textile parts out of the textile sheet formation. The first and second tool components are hereby designed movable to one another relative to one another, for separating out the textile parts.

Non-woven textiles, in particular fibre non-wovens, are becoming increasingly broadly used, in particular in the technical, medical and cosmetic field. The non-woven textiles which are in particular characterised by a combination of non-directed fibres, are often manufactured in the form of extensive sheet formations or webs, e.g. as rolls or reel products. Textile sheet parts, called textile parts here are then separated away from this sheet formation for numerous applications. These textile parts are either already end products or they represent intermediate products which are the object of a further processing into end products. Thus for example cotton pads separated out of an extensive non-woven are applied in cosmetics, e.g. for facial cleaning or for applying make-up and removing it.

### STATE OF THE ART

It is known e.g. to manufacture cotton pads by way of punching out of a textile sheet formation. For this, a tool is applied, which comprises two tool blocks. A lower tool block which as a rule is arranged in a stationary manner contains a plurality of rows with dies. The upper tool block comprises a plurality of rows with working punches. A die is assigned to each working punch. The pairing of the working punch and the die cooperating with one another during the punching procedure forms a punching unit. The working punch contains a punching tool and is guided in a manner movable to the die. The die comprises a receiver opening for receiving the punched-out cotton pads. The punching tool of the working punch comprises a blade which formed a closed cutting contour which as a rule is circular. According to the punching procedure known in the state of the art, the blade of the punching tool is led with a high force against a flat support surface surrounding the die opening, wherein the textile sheet formation is squeezed between the support surface and the blade and is separated. The die opening accordingly has a smaller periphery than that the cotton pad which is punched out on the support surface surrounding the die opening.

The mentioned flat support surface hereby assumes the function of an anvil, onto which the blade of the punching tool strikes and leads to a pinching or squeezing of the fibres in the textile sheet formation until severing. With the punching procedure according to the state of the art therefore, pinching forces are produced, but no shearing forces as is e.g. the case with a conventional cutting procedure. The present method and the associated device have the disadvantage that the blade of the working punch which is led in each case with a high force onto the flat support surface of the die with the punching procedure is blunted relatively quickly and loses its separating effect. The reduction of the separating effect must in turn be compensated by an increase of the already high punching force. The application of relatively high punch forces furthermore lead to a correspondingly high energy consumption on operation. Moreover, the device parts also need to be designed in an accordingly robust manner and of a high quality due to the high punching forces, which in turn increases the tooling costs. Moreover, the high forces which act on the device parts generally leads to a greater wear of the tool and machine.

### DESCRIPTION OF THE INVENTION

It is therefore the object of the invention, to provide a device and a method of the initially mentioned type, which overcome the disadvantages mentioned above.

This object is achieved by the features of the independent claims 1 and 13. Further preferred embodiments and further developments of the invention are to be deduced from the dependent patent claims, the description as well as the drawings. Thereby, features of the method claims with regard to context can be combined with the features of the device claims and vice versa.

The term “cotton” for producing cotton-pads is basically to be understood as a loose structure of fibres and/or threads, which result in a volume structure solely or almost exclusively due to the adhesion amongst one another. The textile sheet formation, from which the textile parts, in particular cotton pads are manufactured, in particular is a non-woven or non-woven material or a fibre non-woven. The non-woven analogously to the “cotton” preferably consist of loose fibres which lie together and which are not yet or to a large part are not yet connected to one another. The strength of a non-woven is based only or almost only on the fibre-related adhesion. It can however be influenced by processing (consolidation). The textile sheet formation can be constructed in a single-layer or multi-layer manner.

The fibres or threads of the textile parts, in particular of the cotton pads, or of the textile sheet formation preferably consist of cellulose, in particular of cotton. The fibres or threads however can also consist of viscose or of synthetic materials such as polyester. The fibres can in particular also comprise microfibers. Mixtures of the previously mentioned materials are also possible.

The invention is thus characterised in that the textile parts, such as cotton pads, are not punched out of a textile sheet material as previously described, but are rather cut out. For this, the first tool component is designed as a die with a first cutting edge encompassing the die opening in a closed manner (peripherally closing the die opening), and the second tool component as a working punch with a second cutting edge. The second cutting edge in particular is likewise designed in a peripherally closed manner.

A pairing of working punch and die which cooperate with one another during the cutting procedure, in each case forms a cutting unit. The die and the working punch are then arranged in the device and led relative to one another, in a manner such that for cutting out textile parts, the second cutting edge can be led past the first cutting edge, at least partly into the die opening.

The second cutting edge thus slides past the first cutting edge, wherein this is to be understood as a relative movement, with which it is not yet to be ascertained as to which cutting edge is actively moved. The textile part is then cut out of the sheet formation when the two cutting edges cross. The two cutting edges together form a closed cutting contour which describes the outline of the separated-away textile part. The closed cutting contour is preferably circular and the textile parts which are manufactured with this cutting contour are preferably round pads. The cutting contour can however also be oval or polygonal or have another closed shape.

The second cutting edge preferably slides practically without a gap or play, past the first cutting edge into the die opening, as this is usual with shearing cutting. The projections of the first and second cutting edge which correspond to the cutting contour are therefore practically congruent to one another taking into account possible tolerances.

The second cutting edge e.g. for carrying out the cut can be introduced into the die opening by 1 mm to 1.5 mm relative to the first cutting edge.

In order to ensure an as wear-free as possible operation of the cutting edges, a certain tolerance between the first cutting edge and the second cutting edge, transverse to the movement direction of the cutting edges is however indeed permissible or desired. The tolerances however are preferably restricted to very small ranges of e.g. 1/1000 to 1/100 mm.

The first cutting edge is now preferably formed of two cutting surfaces which hit one another at an angle of about 90° (angle degrees). Of course, the angular specification can also include deviations from this 90° due to tolerances. The first cutting edge surrounding the die opening as a result represents the edge of a shoulder. A first cutting surface preferably forms a wall of the die recess. A second cutting surface is preferably part of a die support surface for the textile sheet formation.

The second cutting edge is preferably formed from two cutting surfaces which meet one another at an angle of 45-90° (angle degrees), in particular of about 90°. The second cutting edge of the working punch preferably has a first cutting surface which runs parallel to the first cutting surface of the first cutting edge of the die. These two cutting surfaces slide past one another during the cutting process. The two cutting surfaces running parallel to one another usefully likewise lie parallel to the movement direction of the tool components, in particular parallel to the travel direction of the working punch.

The two cutting edges can be designed and arranged relative to one another, as well as guidable in the movement direction, such that with the cutting procedure, the first and the second cutting edges at least in sections and preferably over their entire extension in each case form an angle to one another, thus do not lie parallel to one another, and execute a shear-like cut.

The first cutting edge preferably lies in one geometric plane. The course of the first cutting edge can however also be serrated or corrugated. The deflection of the corrugations, curves or serrations usefully lie parallel to the movement direction of the tool components. The second cutting edge preferably likewise lies in a geometric plane. The course of the second cutting edge can however likewise be undulated in a serrated, corrugated or curved manner. The deflection of the corrugations, curves or serrations here too preferably lies parallel to the movement direction of the tool components.

If the first and the second cutting edge each lie in a plane, then the two planes can be parallel or be at an angle to one another. Such an angle can e.g. be larger than 0° and smaller than 30°, preferably smaller than 15°. In the first case, the two planes running parallel to one another preferably lie perpendicularly to the movement direction of the tool components. With the cutting procedure, the cutting edges simultaneously meet one another over their complete peripheral length. If the two planes however are at an angle to one another or the two cutting edges at least in sections do not lie parallel to one another, e.g. by way of one of the cutting edges having a course undulating in a serrated, corrugated or curved manner, then the cutting edges at least in sections in each case cross at an angle during the cutting procedure. The cutting procedure can be optimised in this manner.

In a preferred embodiment of the invention, the working punch comprises a cutting insert with a hollow-cylinder-shaped cutting section, on whose face side the closed cutting edge is arranged. The hollow-cylinder-shaped cutting section is directed with its cutting edge to the die. The cutting insert is preferably designed as a cutting ring, with a cutting edge designed in an annular or annulus-shaped manner.

The working punch in particular is designed as a hollow punch. The hollow punch preferably contains a plunger which is led in this, for ejecting the textile parts out of the die opening.

According to a preferred further development of the invention, the die comprises a support surface for the edge section of the textile part, said support surface being set back into the die opening with respect to the first cutting edge, in the direction of the cutting travel which is to say in the ejection direction of the working punch. The support surface in particular is part of a shoulder or step in the die recess. The support surface can be designed as a continuous or interrupted surface. The support surface in particular is designed annularly.

The support surface lies at an angle, in particular perpendicularly to the movement direction of the tool components or to the direction of the cutting travel. The support surface, with the wall of the die recess which also forms the first cutting surface of the first cutting edge, preferably forms a common corner region.

The support surface or the step or shoulder which forms the support surface, and the wall of the die recess are preferably an integral component of a common die component manufactured in a single-part manner. The support surface can however also form part of a separately designed embossing member, as explained further below.

Thanks to the support surface, the textile part lies on the support surface in the recess of the die during and/or after the cutting out. One function of the support surface therefore amongst other things lies in ensuring that the textile part is arranged in a directed manner in the recess of the die after the cutting procedure and in particular before or during the ejection procedure. An oblique position of the textile part in the die recess and which would be disadvantageous for the subsequent ejection and stack formation procedure is therefore practically ruled out. The formation of an ordered uniform stack of cut-out textile parts is ensured by way of this.

During the ejection procedure, the textile part lying on the support surface is ejected out of the die in the ejection direction which preferably corresponds to the direction of the cutting travel. Hereby, the textile part is moved away from its rest position on the support surface and through a through-opening surrounded by the support surface, and led to a storage space.

The working punch preferably comprises an end face which is directed to the support surface for the textile part. The end face is preferably designed in an annular manner. If the working punch contains a cutting ring, then the end face is preferably formed by the cutting ring.

The end face preferably forms a second cutting surface of the second cutting edge. The end face preferably extends radially outwards up to the second cutting edge. The end face preferably lies at an angle and in particular perpendicularly to the movement direction of the tool components or of the cutting travel.

The device is preferably designed such that the end face of the working punch and the support surface for the textile part can cooperate with one another in a manner such that the textile part in the framework of a cutting procedure is pressed or pinched in an edge region in a surfaced manner. For this, the end face of the working punch is introduced so far into the die opening during the cutting procedure that the textile part is clamped between the end face of the cutting ring and the support surface and is pressed. A surfaced pressing force is exerted onto the edge region of the textile part, hereinafter called edge pressing.

The strength of the edge pressing can be set in dependence on the textile materials to be processed. This is effected via the setting of the gap size between the support surface and the end face in the maximal immersion depth of the end face. The gap size can e.g. be 0.1 mm or more.

The width of the end face and accordingly the width of the edge pressing can for example be 0.3 to 2 mm, in particular 0.3 to 0.7 mm. The width of the end face is preferably smaller than the width of the support surface for the textile part. This in particular also means that the width of the end face is smaller than the distance between the die wall forming a cutting surface and a second embossing-effective contact surface in the support surface.

Thus the width of the edge pressing in the edge region of the textile part is preferably smaller than the distance between the embossing in the edge region and the terminal edge of the textile part.

For this, the working punch and in particular the cutting ring can comprise a connection surface which is arranged radial inwards, connects to the end face and is set back opposite to the direction of the cutting travel or ejection direction. The connection surface for example borders an embossing insert of the working punch. The connection surface is accordingly also set back with respect to the support surface, so that no or only a small edge pressing onto the textile part is exerted in the region of the connection surface.

The edge pressing is preferably annular. It can be designed in a continuous or interrupted manner. The edge pressing in the edge region of the textile part effects a local compacting of the fibre material. Accordingly, the haptics in the edge region of the textile part also changes. The greater the edge pressing, the harder is also the grip in the edge region.

In a further development of the invention, the working punch comprises an embossing insert with a first embossing-effective edge which is directed to the die, for the purpose of incorporating an edge embossing on the textile part. The embossing insert preferably has a hollow-cylinder-shaped embossing section with an embossing-effective contact surface which is arranged on this at the face side. The hollow-cylinder-shaped embossing section or its embossing-effective contact surface arranged on this at the face side preferably has the same peripheral geometry as the hollow-cylinder-shaped cutting section or the cutting edge arranged on its face side. The embossing insert is preferably arranged concentrically within a hollow-cylinder-shaped cutting section of the cutting insert. The embossing insert is preferably mounted on the working punch via an element which is elastically deformable in the movement direction of the working punch or in the travel direction. The elastic element, seen from the die is arranged behind the embossing insert on the working punch. The embossing insert is this mounted in an elastically resilient manner in the movement direction.

In a particularly preferred further development of the invention, the working punch comprises an annularly designed embossing punch which is arranged within the cutting ring concentrically to this and which forms a first embossing-effective contact surface.

The first embossing-effective contact surface can then be designed as a continuous or interrupted surface, which runs e.g. at the face side along the hollow-cylinder periphery of the embossing insert. The contact surface can also consist of embossing edges, in particular cutting edges, which are arranged at the face side along the hollow-cylinder periphery. The contact surface can in particular be designed as a continuous or interrupted ring surface or can consist of embossing edges, in particular cutting edges, which are arranged along the annular periphery of the embossing punch. The first embossing-effective contact surface can thus also be composed of a multitude of part surfaces, by way of which e.g. a geometric pattern can be embossed or pressed into the textile part.

The first embossing-effective contact surface projects along the movement direction of the tool components with respect to the second cutting edge. This arrangement takes into account the fact that the second embossing-effective contact surface of a counter-member, as is also called embossing member hereinafter, is set back somewhat into the die opening with respect to the first cutting edge.

If the punch comprises an embossing punch, then according to a further development of this embodiment, an additionally embossing member is preferably arranged in the die opening.

The embossing member comprises a second embossing-effective contact surface which is set back into the die opening with respect to the first cutting edge. The second contact surface thus indeed lies in the die opening. The embossing member or the second embossing-effective contact surface can be integrated into the support surface for the textile part. Thus the embossing-effective contact surface can be formed by the step which is to say shoulder which comprises the support surface for the textile part. This means the embossing member can be formed by the contact surface or by the associated shoulder or step.

The embossing member and the wall of the die recess which forms the first cutting surface for the first cutting part are preferably an integral component of a common die component manufactured as one part.

The embossing member can however also be designed as a separate component installed into the die. Thus the embossing member can be designed as a hollow cylinder or with a hollow-cylinder section with a face side directed to the working punch. The embossing member in particular is designed as an embossing sleeve. According to this embodiment, the support surface for the textile part is an integral component of the hollow cylinder or hollow cylinder section and in particular of the embossing sleeve. The second embossing-effective contact surface is e.g. arranged at the face side on the hollow cylinder or on the hollow cylinder section of the embossing member or embossing sleeve.

The second embossing-effective contact surface can be designed as a continuous or interrupted surface which is peripheral at the face side, such as a ring surface or consist of embossing edges, in particular cutting edges which are arranged at the face side along the periphery, in particular ring periphery of the embossing member. The second embossing-effective contact surface can thus be composed of also of a multitude of part-surfaces, by way of which e.g. a geometric pattern can be embossed or pressed into the textile part. The second contact surface can hereby abut on the cutting surface of the first cutting edge.

The second embossing-effective contact surface cooperates with the first embossing-effective contact surface of an embossing punch, e.g. according to the embodiment type mentioned above, for the purpose of incorporating an edge embossing into the textile part. The edge embossing can include a local deformation of the fibre structure and/or the local introduction of cuts in the edge region. Moreover, the edge-embossing can also include a local punching-out or cutting-out of fibre material in the edge region.

One of the embossing-effective contact surfaces, in particular the first contact surface, as described above can be formed of one or a plurality of edges or cutting edges, for introducing limited cuts.

In a further development of the invention, heating means for heating the embossing insert can be provided in the working punch and/or the embossing member in the die.

According to a preferred embodiment of the invention, the working punch, with respect to the direction of gravity, comprises an upper tool component, and the die a lower tool component. The die preferably forms a support surface for the textile sheet formation. The die support surface is e.g. arranged horizontally. The device then contains a plurality of cutting units which are arranged next to one another, e.g. in several rows. A cutting unit is thereby designed for cutting textile parts out of the sheet material and comprises in each case a working punch and a die. The die support surface is preferably designed as a continuous surface which extends over a multitude of cutting units arranged next to one another. The die support surface is accordingly broken through by a plurality of die openings which are preferably arranged in rows next to one another. This permits a textile sheet formation to spread out over several cutting units and the simultaneous cutting of textile parts out of the sheet material at several locations. The textile sheet formation for this can be led continuously to the device, preferably as a material web. The cutting units or the working punches of the individual cutting units are therefore preferably operated or moved via a common actuator mechanism in the same cycle rate.

According to a preferred further development of the invention, in one working cycle the working punch is lowered to the die opening for implementing the cutting procedure. This corresponds to the so-called cutting travel. The die thereby preferably remains stationary. After completion of the cutting procedure and a possible embossing, the working punch is refracted upwards again into its starting position and the working cycle is completed. The working punch thus executes a working travel. However, it is also possible instead for the die to be led to the working punch or for both tool components to be moved, e.g. for both tool components to be led to one another and away from one another in oppositely directed movements. The movement direction of the tool component(s) thereby preferably lies parallel to the direction of gravity.

The invention moreover also relates to a method for manufacturing textile parts, in particular cotton pads, from a textile sheet formation amid the use of the device according to the invention. The method is characterised by the following steps:
placing a textile sheet formation on a die support surface of the device;
leading together the first cutting edge of the die with the second cutting edge of the punch;
leading the second cutting edge past the first cutting edge and at least partly introducing the second cutting edge into the die opening amid the execution of a cut and the cutting of a textile part out of the textile sheet formation;
retracting the second cutting edge of the working punch out of the die opening.

In a preferred further development of the method, an edge embossing is carried out on the textile part, in the die opening, during or after leading the second cutting edge past the first cutting edge and before retracting the second cutting edge of the working punch out of the die opening.

According to a further development of the method, an edge pressing is carried out on the textile part, in the die opening, during or after leading the second cutting edge past the first cutting edge and before retracting the second cutting edge of the working punch out of the die opening.

According to a further development of the method, the working punch comprises a cutting insert with a cutting edge and an embossing insert which forms a first embossing-effective contact surface. An embossing member is arranged in the die opening and comprises a second embossing-effective contact surface which is set back into the die opening with respect to the first cutting edge. The embossing insert together with the cutting insert is led to the die.

The embossing insert and the cutting insert according to this further development are arranged relative to one another and are moved to one another, in a manner such that the embossing insert with its embossing-effective contact surface comes to interact with the embossing-effective contact surface of the embossing member for the propose of carrying out an embossing, only after carrying out the separating cut.

However, one can also envisage the embossing punch being movable to the die relative to the cutting ring and being guided relative to the cutting ring in a manner such that the embossing punch with its first embossing-effective contact surface comes to interact with the second embossing-effective contact surface of the embossing member for the purpose of carrying out an embossing, only during or after carrying out the separating step.

Thus three working steps can be carried out in one work run with the method according to the invention, specifically:
A. cutting out the textile parts, in particular cotton pads, out of a textile sheet formation;
B. Incorporating an embossing into the edge region of the textile part;
C. Incorporating an edge pressing on the textile part.

The working steps B and C are thereby optional as already mentioned. Thus the method according to the invention can comprise only the working step A, the working steps A and B, or the working steps A, B and C.

The device according to the invention and the associated method has the advantage that the textile parts or cotton pads are separated from the textile sheet formation by a cutting procedure. With this procedure, the fibres are separated between the cutting edges, wherein a precise cut is produced. In contrast to the method according to the state of the art, with which the fibres are pinched, here a fraying at the separating edges does not occur. The cutting procedure moreover in contrast to punching requires less force and accordingly less operating power. Thus for example one half to a third of the force applied until now for punching out the cotton pads until is sufficient for cutting out the cotton pads. By way of this, the wear on the tool parts and machine parts can be reduced and energy saved. Moreover the actuator means for producing the cutting force can be accordingly re-dimensioned as a result of the lower power requirement. The tool can generally be constructed lighter and with less expensive materials.

Since the cutting edges slide past one another during the separating cut, as is typical for a cutting procedure, and do not abut on a counter element, the wearing of the cutting edges is comparatively low. Basically, metal onto metal contacts are avoided with the device according to the invention. Even with the edge pressing, the end face of the working punch and the support surface in the die recess does not directly hit one another.

The tool components thus in comparison to the punch blades according to the state of the require considerable less maintenance, so that standstill times of the device on account of maintenance work, such as e.g. replacing punching tools, can be reduced.

### BRIEF DESCRIPTION OF THE DRAWINGS

The subject-matter of the invention is hereinafter explained in more detail by way of preferred embodiment examples which are represented in the accompanying drawings. In each case are shown schematically in:

FIG. 1a: a lateral view of a device for separating away cotton pads out of a textile sheet formation, according to the state of the art;

FIG. 1b: an enlarged detail A of the sectioned representation according to FIG. 1a:

FIG. 2a: a lateral view of a device according to the invention, for separating cotton pads out of a textile sheet formation;

FIG. 2b: a section through the device according to FIG. 2a, along the line B-B;

FIG. 2c: an enlarged detail C from the sectioned representation according to FIG. 2b;

FIG. 3a: a schematic cross-sectional representation from the cutting region of the device according to the invention, according to a first embodiment variant;

FIG. 3b: a schematic cross-sectional representation from the cutting region of the device according to the invention, according to a second embodiment variant;

FIG. 4: a perspective representation of a device according to the invention;

FIG. 5: a textile sheet formation with cut-out cotton pads.

Basically, in the figures, the same parts are provided with the same reference numerals.

### WAYS OF CARRYING OUT THE INVENTION

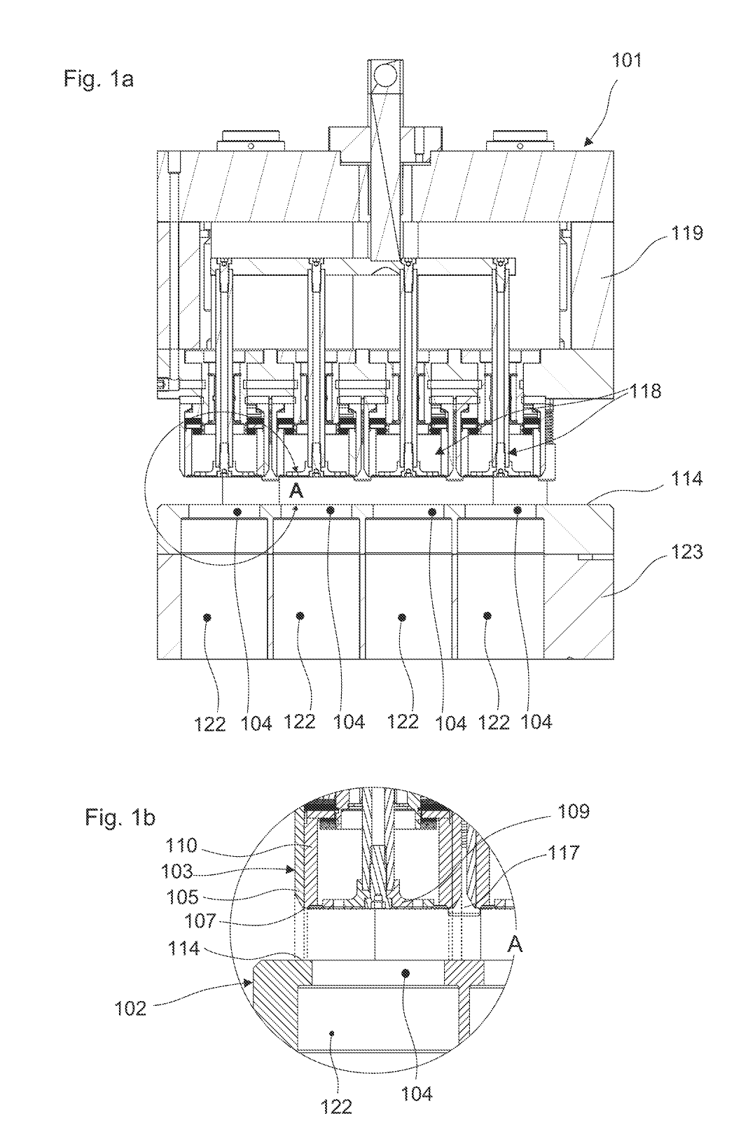

FIGS. 1a and 1b show a punching device 101 for punching cotton pads out of a cellulose web, according to the state of the art. The punching device 101 comprises an upper frame 119 and a lower frame 123. The punching device 101 moreover comprises a plurality of punching units 118 in each case with a die 102 and a working punch 103 which cooperate with one another. The working punches 103 are arranged in the upper frame 119. The dies 102 with their die opening 104 are arranged in the lower frame 123. A pairing of a working punch 103 and die 102 in each case forms a punching unit 118.

The working punch 103 is designed as a hollow punch and contains an outer punching ring 105 which forms a punching edge 107. The punching edge 107 of the punching ring 105 cooperates with a flat support surface 114 of the die 102 which surrounds the die opening 104. The working punch 103 furthermore comprises an inner-lying annular embossing punch 110 for incorporating an edge embossing on the cotton pad. The embossing punch 110 comprises an embossing-effective contact surface which cooperates with the flat support surface 114 of the die. In each case a hold-against punch 117 is arranged between two punching units 118 in the upper frame 119. The hold-against punches 117 serve for fixedly clamping the material web on the support surface 114 and for this are displaceably guided against this surface.

As is evident from FIG. 1b, the punching edge 107 of the punching ring 105 cooperates with the flat support surface 114 of the die 102 which here executes the function of an anvil. The punching-out occurs with the pinching or squeezing of the fibres in the region of the punching edge 107, which entails a considerable pressing force which is transmitted by the punching ring 105 onto the fibre formation. For carrying out an edge pressing, the embossing punch 110 or its embossing-effective contact surface likewise cooperates with the flat support surface 114 of the die 102. The embossing-effective contact surface of the support surface 114 lies within the annular punching surface and concentrically to this, but outside the die opening 104.

The working punch 103 moreover comprises a plunger for ejecting the punched-out cotton pads through the die opening 104 into a storage space 122. Since the punching edge 106 hits the support surface 114 of the die 102 outside the die opening 104, the die opening 104 has a smaller diameter than the cotton pad.

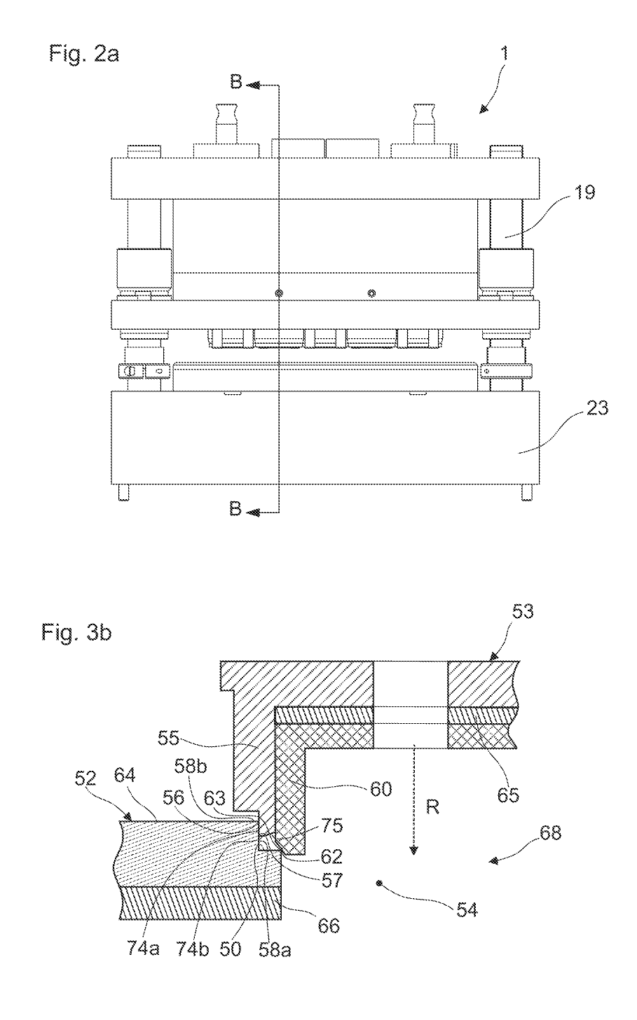

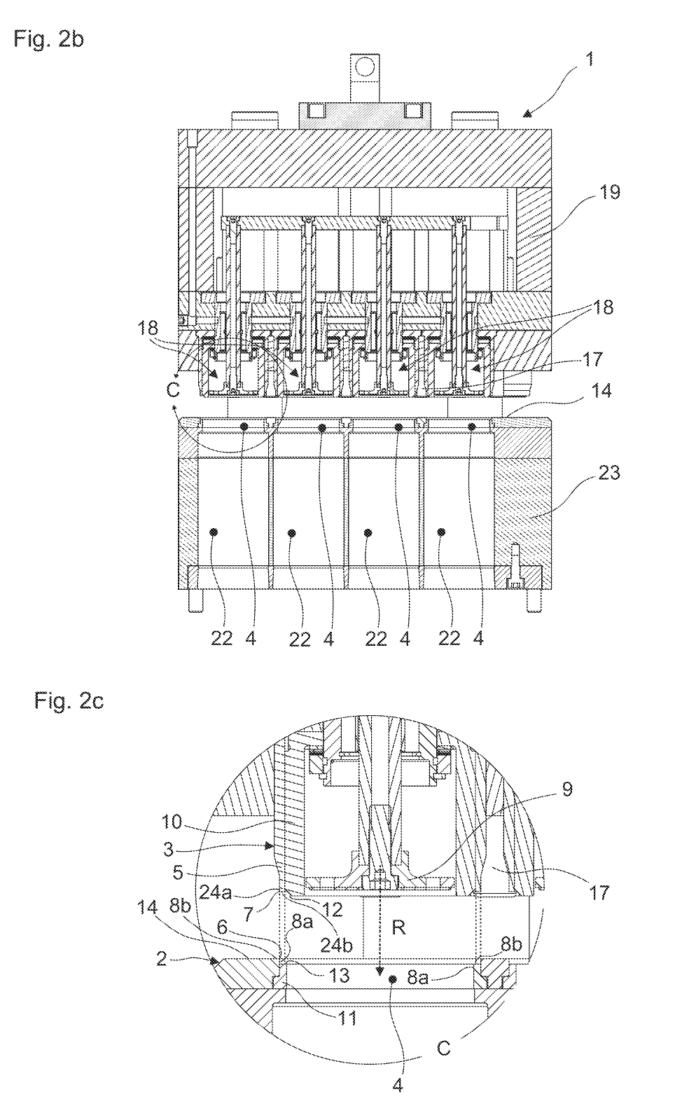

FIGS. 2, 3a and 4 show a particular embodiment of a device according to the invention, for separating cotton pads out of a textile sheet material.

The device according to the invention has a similar basic construction as the punching device according to FIG. 1 which is described above. The device 1 likewise comprises an upper frame 19 and a lower frame 23. The device 1 moreover comprises a plurality of cutting units 18, each with a die 2 and a working punch 3 which cooperate with one another with the cutting procedure. The working punches 3 are each arranged in the upper frame 19. The dies 2 are arranged each with their die openings 4 in the lower frame 23.

The die 2 forms a first closed cutting edge 6 which surrounds the die opening 4 and represents the delimitation of the die opening 4 to the die support surface 14. The first cutting edge 6 is formed by two cutting surfaces 8a, 8b which meet at a right angle, wherein a first cutting surface 8a forms a wall of the die opening 4 and is orientated parallel to the travel direction R of the punch, and a second cutting surface 8b is part of the die support surface 14 and is accordingly arranged perpendicular to the first cutting surface 8a.

The working punch 3 is designed as a hollow punch and comprises an outer cutting ring 5 which forms a second, closed, annular cutting edge 7. The second cutting edge 7 is formed by two cutting surfaces 24a, 24b which meet at a right angle, wherein a first cutting surface 24a is arranged parallel to the travel direction R of the punch, and a second cutting surface 24b accordingly perpendicularly thereto.

The second cutting surface 24b is designed as an end face which cooperates with a subsequently described support surface 30 for exerting an annular edge pressing onto the cotton pad 21.

The working punch 3 moreover contains an inner-lying, annular embossing punch 10 which is arranged concentrically to the cutting ring 5, for incorporating an edge-embossing on the cotton pad 21. The embossing punch 10 to the top, thus at a side lying opposite to the die 2, is attached or mounted on the working punch 3 or on the cutting ring 5 via an elastic damping element 15, e.g. of Vulkollan. The embossing punch 10 comprises a first embossing-effective contact surface 12 which with respect to the cutting edge 7 of the cutting ring 5 projects e.g. by 1-1.4 mm, in particular 1.2 mm.

The die 2 comprises an underlay 16 which can likewise be designed as an elastic damping element. The underlay 16 is supported on the lower frame 23 for example via a hold-against plate (not shown).

An embossing sleeve 11 is arranged on the die 2 or in the die opening 4. The embossing sleeve 11 forms a support surface 30 for the cotton pad 21, said support surface being set back into the die opening 4 in the direction of the cutting travel R, relative to the first cutting edge 6. The support surface 30 lies perpendicularly to the travel direction R. The support surface 30 is part of a shoulder which is formed radially in the die opening 4 by the embossing sleeve 11. This shoulder or also called step effects at least a local narrowing of the die opening 4.

The support surface 30 comprises a second, embossing-effective contact surface 13. This contact surface 13 is likewise accordingly set back into the die opening 4 with respect to the first cutting edge 6. The embossing-effective contact surface 13 is arranged in a radially inwardly lying region of the annular support surface 13. The support surface 30 or the second contact surface 13 with respect to the cutting edge is set back into the die opening 4 for example by 1 to 3 mm, in particular by 1.5 mm.

The embossing sleeve 11 is fixed in the die opening 4 between the die underlay 16 and the die 2. The embossing sleeve 11 for this on the outer periphery has an annular shoulder which is embedded or clamped between the die 2 and the underlay 16 and thus prevents the embossing sleeve 11 from displacing along the travel direction.

The support surface 30 with the second embossing-effective contact surface 13 is designed as a ring surface which abuts on the first cutting surface 8a of the first cutting edge 6. The width of this ring surface is e.g. 1.5 to 2.5 mm, in particular 2 mm. The second embossing-effective contact surface 13 for the purpose of incorporating an edge embossing into the cotton pad 21 cooperates with the first embossing-effective contact surface 12 of the embossing punch 10, e.g. according to the embodiment type mentioned above. The edge embossing in the present example effects the local introduction of cuts combined with a local deformation of the fibre structure in the edge region. For this, the first embossing-effective contact surface 12 of the embossing punch 10 comprises a plurality of edges which in the embossing position form linear contacts to the second contact surface 13.

A hold-against punch 17 is arranged in each case between two punching units 18, in the upper frame 17. The hold-against punch 17 serves for the fixed clamping of the sheet material on the support surface 14 and for this is displaceably guided to this amid the build-up of a pressing pressure. The hold-against punch 17 for this is likewise guided against the sheet material 20 or against the support surface 14 by way of a travel movement which is equally directed to the travel direction R of the working punch 3.

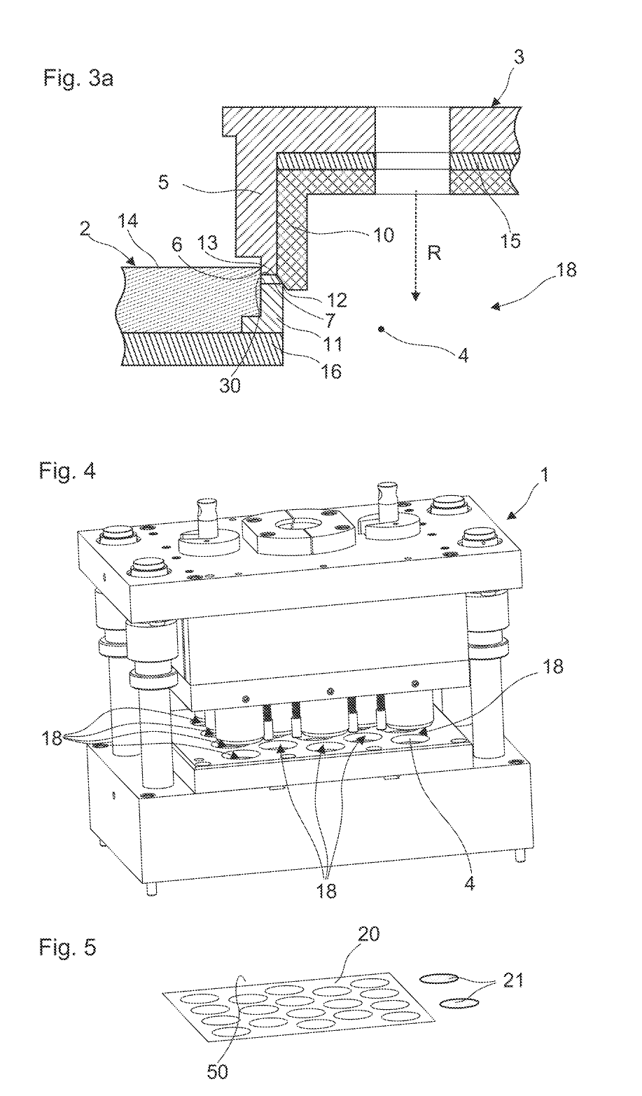

FIG. 3b shows an embodiment variant to the arrangement according to FIG. 3a. The arrangement according to FIG. 3b however can be likewise applied in a device according to FIGS. 2 and 4.

The die 52 likewise forms a first, closed cutting edge 56 which surrounds the die opening 54 and represents the delimitation of the die opening 54 to the die support surface 64. The first cutting edge 56 is formed by two cutting surfaces 58a, 58b meeting at a right angle, wherein a first cutting surface 58a forms a wall of the die opening 54 and is orientated parallel to the travel direction R of the punch, and a second cutting surface 58b is part of the die support surface 64 and is accordingly arranged perpendicularly to the first cutting surface 58a.

The working punch 53 is designed as a hollow punch and comprises an outer cutting ring 55 which forms a second, closed annular cutting edge 57. The second cutting edge 57 is formed by two cutting surfaces 74a, 74b which meet at a right angle, wherein a first cutting surface 74a is arranged parallel to the travel direction R of the punch and a second cutting surface 74b accordingly perpendicularly thereto.

The second cutting surface 74b is designed as an end face which cooperates with a subsequently described support surface 50 for exerting an annular edge pressing onto the cotton pad 21. An inclined connection surface 75 connects radially inwards onto the second cutting surface 74b and due to its inclination is arranged set back with respect to the second cutting surface 74b oppositely to the direction R of the cutting travel. The connection surface 75 is adjacent a subsequently described embossing punch 60.

The working punch 53 moreover comprises an inner-lying, annular embossing punch 60 which is arranged concentrically to the cutting ring 55, for applying an edge embossing on the cotton pad 21. The embossing punch 60 to the top, thus on a side lying opposite the die 52, is attached or mounted on the working punch 53 or on the cutting ring 55 via an elastic damping element 65. The embossing punch 60 comprises a first embossing-effective contact surface 62 which projects with respect to the cutting edge 57 of the cutting ring 55.

The die 52 likewise comprises an underlay 66 which is likewise designed as an elastic damping element. The underlay 66 is supported for example via a hold-against plate (not shown) on the lower frame.

The die 52 moreover comprises a support surface 50 which is arranged set back into the die opening 54 in the direction of the cutting travel R. The support surface 50 is formed by an annular shoulder which is arranged radially in the die opening. This shoulder or also called step effects an at least local narrowing of the die opening 54.

The support surface 50 is designed as a ring surface which borders the cutting surface 58a of the first cutting edge 56. The support surface 50 is integrally connected to the cutting surface 58a.

The support surface 50 comprises a second, embossing-effective contact surface 63. This contact surface is likewise accordingly set back into the die opening 54 with respect to the first cutting edge 56. The second, embossing-effective contact surface 13 is arranged in a radially inner-lying region of the annular support surface 30.

The support surface 50 or the second contact surface 63 is set back with respect to the first cutting edge 56, for example by 1 to 3 mm, in particular by 1.5 mm, into the die opening 54.

The second embossing-effective contact surface 63 for the purpose of incorporating an edge embossing into the cotton pad 21 cooperates with the first embossing-effective contact surface 62 of the embossing punch 60, e.g. according to the embodiment type mentioned above. The edge embossing in the present embodiment example effects the local introduction of cuts combined with a local deformation of the fibre structure in the edge region. For this, the first embossing-effective contact surface 62 of the embossing punch 60 comprises a plurality of edges which in the embossing position form linear contacts to the first contact surface 63.

As is evident from FIGS. 2c and 3a and 3b, the cutting edge 7, 57 of the cutting ring 5, 55 when lowering the working punch 3, 53 towards the die 2, 52, slides past the cutting edge 6, 56 of the die to some part into the die opening 4, 54. The two cutting edges 6, 66; 7, 67 are led past one another in a practically gap-free manner with extremely low tolerances. Thus the two cutting surfaces 8a, 24a; 58a, 74a are led past one another in a laterally offset manner e.g. with a tolerance of only 5/1000 mm-3/100 mm, preferably 1/100 mm. With this procedure, a cotton pad 21 is cut out of the sheet formation 20 in a shearing step (see also FIG. 5).

On lowering the working punch 3, 53 in the direction of the die opening 4, 54, an annular surface section of the cotton pad 21 is clamped and pressed between the support surface 30, 50 and the end face 24b, 74b of the cutting ring 55. The cotton pad 21 experiences an annular edge pressing.

The annular edge pressing, departing from the outer-lying edge of the cotton pad 21 extends radially inwards in the direction of the edge embossing. The edge embossing however in the present case does not extend up to the edge embossing. This is because no or a significantly lower pressing force is exerted onto the cotton pad 21, in an annular section which is arranged between the edge pressing and the edge embossing, on account of the set-back connection surface 75.

The embossing punch 10, 60 is lowered together with the cutting ring 5, 55 for carrying out an edge embossing in the same working run. The embossing-effective contact region 12, 62 of the embossing punch 10, 60 is arranged with respect to the cutting edge 7, 57 such that this edge only comes to interact with the embossing-effective contact region 13, 63 of the embossing sleeve 11, 61 in the die 2, 52, when the cutting procedure is underway or is already completed. The edge embossing is thus carried out in an overlapping manner with the cutting procedure or thereafter and before the refraction of the working punch 3, 53 out of the die opening 2, 52. With this procedure, the cutting edge 7, 57 of the working punch during or after the cut, slides along the cutting surface 8a, 58a some distance into the die opening 4, 54, until the two embossing-effective contact surfaces 12, 13; 62, 63 hit one another for carrying out the embossing.

The working punch 3, 53 moreover comprises a centric opening, in which a plunger 9 is guided. This serves for ejecting the punched-out cotton pads 21 through the die opening 4, 54 into a storage space 22 lying therebelow. The plunger 9 after completion of the edge embossing is extended in the direction of the cotton pad 21 before or during the retraction of the working punch 3, 53.

1. A device for separating textile parts, in particular cotton pads, out of a textile sheet formation, comprising:
at least one first tool component with a receiver opening for receiving separated-away textile parts;
at least one second tool component cooperating with the first tool component and having a separating tool for separating away textile parts out of the textile sheet formation,
wherein the first and the second tool components are designed movable to one another relative to one another for separating away textile parts
wherein the first tool component is designed as a die with a first cutting edge encompassing the die opening in a closed manner, and the second tool component is designed as a working punch with a second cutting edge, wherein the die and the working punch are arranged in the device and guided relative to one another, in a manner such that for cutting out textile parts, the second cutting edge is guidable past the first cutting edge, at least partly into the die opening.

2. A device according to claim 1, wherein the first and/or the second cutting edge is formed from two cutting surfaces which meet one another at an angle of 85-90° (angle degrees).

3. A device according to claim 1, wherein the die comprises a support surface for the textile part, said support surface being set back into the die opening with respect to the first cutting edge.

4. A device according to claim 1, wherein the working punch is a hollow punch with a plunger guided in this, for ejecting the textile parts out of the die opening.

5. A device according to claim 1, wherein the first cutting edge is designed circularly, ovally or polygonally.

6. A device according to claim 1, wherein the second cutting edge is designed circularly, ovally or polygonally, and the geometric shape of the projections of the first and second cutting edge are identical.

7. A device according to claim 1, wherein the working punch comprises a cutting insert with a hollow-cylinder-shaped cutting section and a cutting edge arranged on this at the face side, and a cutting ring with an annularly designed cutting edge.

8. A device according to claim 1, wherein the first and the second cutting edge in each case lie in a plane, and the two planes of the cutting edges are arranged parallel to one another or are at an angle to one another for forming a shearing cut.

9. A device according to claim 1, wherein the working punch comprises an embossing insert with a first embossing-effective contact surface.

10. A device according to claim 7, wherein the working punch comprises an embossing insert, with a hollow-cylinder-shaped embossing section, said insert being arranged within the cutting insert within the hollow-cylinder-shaped cutting section, and within the cutting ring, and comprises an annular embossing punch forming a first embossing-effective contact surface.

11. A device according to claim 1, wherein an embossing member is arranged in the die opening, said embossing member having a second embossing-effective contact surface which is set back into the die opening with respect to the first cutting edge and which cooperates with a first embossing-effective contact surface of an embossing punch, for the purpose of incorporating an embossing into the textile part.

12. A device according to claim 1, wherein the working punch is an upper tool component, and the die is a lower tool component, and the die forms a die support surface for the textile sheet formation, and the working punch is designed in a manner lowerable to the die opening.

13. A method for manufacturing textile parts, in particular cotton pads, from a textile sheet formation comprising the following steps:
providing a device having at least one first tool component with a receiver opening for receiving separated-away textile parts, at least one second tool component cooperating with the first tool component and having a separating tool for separating away textile parts out of the textile sheet formation, wherein the first and the second tool components are designed movable to one another relative to one another for separating away textile parts, and wherein the first tool component is designed as a die with a first cutting edge encompassing the die opening in a closed manner, and the second tool component is designed as a working punch with a second cutting edge, wherein the die and the working punch are arranged in the device and guided relative to one another, in a manner such that for cutting out textile parts, the second cutting edge is guidable past the first cutting edge, at least partly into the die opening,
placing a textile sheet formation on a support surface of the device;
leading-together the first cutting edge of the die with the second cutting edge of the working punch;
leading the second cutting edge past the first cutting edge and at least partly introducing the second cutting edge into the die opening amid the execution of a cut and the cutting of a textile part out of the textile sheet formation;
retracting the second cutting edge of the working punch out of the die opening.

14. A method for manufacturing textile parts according to claim 13, wherein in the die opening, an edge pressing is carried out on the textile part during and/or after leading the second cutting edge past the first cutting edge and before withdrawing the second cutting edge of the working punch out of the die opening.

15. A method for manufacturing textile parts (21) according to claim 13, in that wherein in the die opening, an edge pressing is carried out on the textile part during and/or after leading the second cutting edge past the first cutting edge and before withdrawing the second cutting edge of the working punch out of the die opening.

16. The device according to claim 2, wherein the two cutting surfaces meet one another at an angle of 90°.

17. The device according to claim 9, wherein the embossing insert is an embossing punch.
